(19) United States
(12) Patent Application Publication
(10) Pub. No.: US 2013/0068237 A1
(43) Pub. Date: Mar. 21, 2013

(54) DENTAL APPLIANCE AND RELATED METHODS OF MANUFACTURE

(71) Applicants: Mark H. Herman, Minneapolis, MN (US); William Cook, Lakeville, MN (US)

(72) Inventors: Mark H. Herman, Minneapolis, MN (US); William Cook, Lakeville, MN (US)

(73) Assignee: BITE TECH, INC., Norwalk, CT (US)

(21) Appl. No.: 13/701,478

(22) PCT Filed: May 31, 2011
(86) PCT No.: PCT/US11/38643

§ 371 Date: Nov. 30, 2012

Related U.S. Application Data
(60) Provisional application No. 61/350,295, filed on Jun. 1, 2010.

(51) Int. Cl. A61C 5/14; A61C 5/10

(52) U.S. Cl. 128/862; 128/861; 29/896.1

(57) ABSTRACT

A dental appliance, related methods of manufacture, and compositions of matter are disclosed herein. In various aspects, the dental appliance may include material layers bonded to one another. The bond between the material layers may be formed, at least in part, by interdigitation of the material layers with one another. Methods of forming the interdigitation are disclosed herein. Compositions of matter that may include interdigitated material layers are disclosed herein.

### CROSS-REFERENCE TO RELATED APPLICATIONS

This application claims the priority and benefit of U.S. Provisional Patent Application 61/350,295 filed 1 Jun. 2010 and entitled “DENTAL APPLIANCE AND RELATED METHODS OF MANUFACTURE”, which is incorporated herein by reference in its entirety.

### BACKGROUND OF THE INVENTION

1. Field

The present disclosure relates to dental appliances for use generally within the mouth including related methods of manufacture and compositions of matter.

2. Description of the Related Art

A dental appliance, in various aspects, may be a mouth guard that offers protection to the user while the user is engaged in various sporting or other physical activities. In various aspects, the dental appliance may offer various other benefits to the user apart from protection, and/or may support anatomical features of head and neck including the mouth. In various aspects, the dental appliance may be removably received within the mouth of the user.

The dental appliance may be constructed, at least in part, of multiple layers of materials bonded to one another. Each layer of material may perform a particular function such as allowing the dental appliance to be fitted to the user, engaging with the teeth of the user, conferring various mechanical properties to the dental appliance, absorbing energy, and so forth.

While generally in use, the dental appliance may be subjected to various forces. For example, the dental appliance may be subjected to mechanical forces applied to the user as a consequence of the user's participation in sport or other activity or merely as a result of routine life events. The user may bite upon the dental appliance. When the dental appliance is removable, the user may remove the dental appliance from its secured position in the mouth while retaining the dental appliance generally in the mouth, and then chew the dental appliance, manipulate the dental appliance with the lips, and so forth. Such actions and their attendant forces, as well as other forces and actions to which the dental appliance may be subjected, may cause, for example, bond failure, and, hence, separation of the material layers from one another. This results in failure of the dental appliance.

Accordingly, there is a need for dental appliances with the material layers bonded to one another in ways that may generally resist separation, as well as related methods and compositions of matter.

### BRIEF SUMMARY OF THE INVENTION

These and other needs and disadvantages are overcome by the methods, systems, and compositions of matter disclosed herein. Additional improvements and advantages may be recognized by those of ordinary skill in the art upon study of the present disclosure.

A dental appliance is disclosed herein. In various aspects, the dental appliance includes a base that is formed from a base material and has indentations disposed thereabout. The dental appliance may include an occlusal pad comprised of an occlusal pad material transformable between a non-pliant state and a pliant state. The occlusal pad may be interdigitated with the indentations of the base, and the occlusal pad may define an occlusal pad channel adapted to engage one or more teeth of a user. The base material differs from the occlusal pad material in various aspects.

Methods of manufacture of the dental appliance are disclosed herein. In various aspects, the methods include the steps of creating indentations in a base, the base comprising a base material, and interdigitating an occlusal pad with the indentations in the base, the occlusal pad comprising occlusal pad material differing from the base material, the occlusal pad adapted for fitably engaging one or more teeth of a user.

Compositions of matter for a portion of a dental appliance are disclosed herein. In various aspects, the compositions of matter include a base comprised of a base material and having indentations disposed thereabout, an occlusal pad comprised of a occlusal pad material for fittable engagement with one or more teeth of the upper jaw, the occlusal pad interdigitated with the indentations of the traction pad. The base material comprises a material chosen from the group consisting of styrene block copolymer, ethylene vinyl acetate, polyolefin elastomer, thermoplastic rubber, polypropylene, and injection molding resin in various aspects. The occlusal pad material, in various aspects, comprises a material chosen from the group consisting of polycaprolactone, ethylene vinyl acetate, and polyolefin elastomer.

This summary is presented to provide a basic understanding of some aspects of the methods disclosed herein as a prelude to the detailed description that follows below. Accordingly, this summary is not intended to identify key elements of the methods, systems, and compositions of matter disclosed herein or to delineate the scope thereof.

### BRIEF DESCRIPTION OF THE DRAWINGS

FIG. 1A illustrates by front perspective view an exemplary implementation of a dental appliance;

FIG. 1B illustrates by bottom perspective view the exemplary implementation of the dental appliance of FIG. 1A;

FIG. 1C illustrates by an exploded perspective view the exemplary implementation of the dental appliance of FIG. 1A;

FIG. 2 illustrates by a cut-away view portions of the exemplary implementation of the dental appliance of FIG. 1A and related exemplary compositions of matter;

FIG. 3 illustrates by a cut-away view portions of another exemplary implementation of a dental appliance and related exemplary compositions of matter;

FIG. 4 illustrates by an exploded view an exemplary implementation of a dental appliance;

FIG. 5 illustrates by a top view portions of an exemplary implementation of a dental appliance;

FIG. 6 illustrates by process flow chart an exemplary method of forming at least a portion of a dental appliance;

FIG. 7 illustrates by process flow chart another exemplary method of forming at least a portion of a dental appliance;

FIG. 8A illustrates by perspective view an exemplary implementation of a dental appliance; and,

FIG. 8B illustrates by cut-away view portions of the exemplary implementation of a dental appliance of FIG. 8A.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof.

### DETAILED DESCRIPTION OF THE INVENTION

A dental appliance and related methods of making the dental appliance and compositions of matter are disclosed herein. The dental appliance disclosed herein, in various aspects, is generally receivable within the mouth of a user, and may be removably secured to at least a portion of the teeth of the user. In various aspects, the dental appliance is configured as a mouth guard for the protection of the teeth, tongue, lips, mandible, or other anatomical features of the mouth, jaw, or face. The dental appliance may support various anatomical features of the mouth, jaw, or face such as, for example, the temporomandibular joint, in various aspects. The dental appliance, in various aspects, may perform other functions such as, for example, the reduction of snoring, as would be recognized by those of ordinary skill in the art upon study of this disclosure.

The dental appliance may be constructed of a plurality of material layers bonded or otherwise secured to one another in various ways. As described herein, one of the material layers of the plurality of material layers is a base, and another of the material layers is an occlusal pad. The dental appliance may be constructed, at least in part, of the base bonded to the occlusal pad, and the base with the occlusal pad bonded thereto forms at least a portion of the dental appliance. In various aspects, the base may support the occlusal pad, may interact with other elements of the dental appliance, and may confer various mechanical properties upon the dental appliance. In various aspects, the occlusal pad may engage the user's teeth to secure the dental appliance thereto, and the occlusal pad may be custom fitted to engage the user's teeth.

In order to bond the base to the occlusal pad, a number of indentations may be disposed about the base. The occlusal pad may be bonded to the base by interdigitation of the occlusal pad into the indentations of the base. Interdigitation of the base and the occlusal pad may bond the base to the occlusal pad in a way generally resistive to the repeated application of oral forces, such as manipulation by the tongue, chewing, sucking, manipulation by the lips, and so forth, as well as the application of other forces. Accordingly, by being so bonded to one another, the occlusal pad and the base may be resistive to separation from one another.

The base is composed of one or more base materials. In various aspects, the base material may include a mixture of styrene block copolymer and ethylene vinyl acetate (EVA). An exemplary styrene block copolymer is available as DYNAFLEX® part number G2782 from GLS Corporation, Thermoplastic Elastomers Division, 833 Ridgeview Dr., McHenry, Ill. 60050. EVA is available from a number of sources, such as the ELVAX® resins from Dupont Packaging and Industrial Polymers, 1007 Market Street, Wilmington, Del. 19898.

In various aspects, the base material may include a mixture of a styrene block copolymer and a polyolefin elastomer. The polyolefin elastomer may be a copolymer of ethylene and octene-1. An exemplary copolymer is available as ENGAGE® from Dupont Canada, Inc., P.O. Box 2200, Streetsville, Mississauga, Ontario L5M 2H3.

The base material may include, in various aspects, a mixture of a thermoplastic rubber, which includes thermoplastic elastomer and thermoplastic urethane, with a polyolefin elastomer. Exemplary thermoplastic rubbers are Santoprene® thermoplastic elastomer from Advanced Elastomer Systems, L. P., 388 South Main Street, Akron, Ohio 44311 and Kraton® thermoplastic elastomer from the Shell Oil Company, Houston, Tex. Kraton® includes a styrene-ethylenelbutylenes-styrene block copolymer. In various aspects, the base material may include polypropylene part number AP6112-HS from Huntsman Corporation, Chesapeake, Va. 23320. In various aspects, the base material of base 20 may include HD-6706 ESCORENE® Injection Molding Resin [a high density polyethylene] from ExxonMobil Chemical Company, P.O. Box 3272, Houston, Tex. In some aspects, the base material of the base has a Shore A hardness of about 82.

The occlusal pad is composed of one or more occlusal pad materials. The occlusal pad material may be transformable between a pliable state and a non-pliable state. In the pliable state, the occlusal pad material of the occlusal pad may be shaped to conform to the teeth of the user. In the non-pliable state, the occlusal pad material of the occlusal pad generally retains its conformance to the teeth of the user as shaped when in the pliable state. In various aspects, the occlusal pad may be transformed between the pliable state and the non-pliable state by heating and cooling, respectively. For example, heating the occlusal pad material in warm water may allow the occlusal pad to be fitted to the user's teeth and, after having been fitted, the occlusal pad material may be cooled to the non-pliant state thereby capturing the fit of the user's teeth in the occlusal pad material. The occlusal pad material is transformed from the non-pliable state to the pliable state at a temperature tolerable by the user upon placement of the occlusal pad material in the pliable state within the user's mouth, in various aspects. The occlusal pad material may transform between the non-pliant and pliant state at a temperature greater than human body temperature but less than about 100° C., in various implementations.

In various aspects, the occlusal pad material of the occlusal pad includes a mixture of polycaprolactone. An exemplary polycaprolactone is Capra 6500 polycaprolactone from Perstorp, UK Limited, Warrington, Cheshire UK. In various aspects, the occlusal pad material of occlusal pad 40 includes a mixture of polycaprolactone and ethylene vinyl acetate (EVA) such as ELVAX®. In various aspects, the occlusal pad material of occlusal pad 40 includes ethylene vinyl acetate (EVA) alone, such as ELVAX®. In various aspects, the occlusal pad material of occlusal pad 40 includes a mixture of polycaprolactone and a polyolefin elastomer, and the polyolefin elastomer may be a copolymer of ethylene and octene-1. An exemplary copolymer is available as ENGAGE® from Dupont Canada, Inc., P.O. Box 2200, Streetsville, Mississauga, Ontario L5M 2H3.

Methods of making the dental appliance are disclosed herein. The methods may include creating indentations in a base and interdigitating an occlusal pad into the indentations in the base thereby bonding the base and the occlusal pad to one another. In various aspects, the interdigitation of the base with the occlusal pad is formed by heating the occlusal pad material of the occlusal pad to a flowable state, and contacting the occlusal pad material with the base such that occlusal pad material flows into the indentations. Then, upon cooling, the occlusal pad material is placed in a generally non-flowable state, and the occlusal pad material of the occlusal pad is interdigitated into the indentations of the base thereby forming a unitary base-occlusal pad material structure. In various aspects the methods may include annealing the base and/or treating the base with the electrical discharge surface treatment prior to boding the base and the occlusal pad to one another.

Compositions of matter are disclosed herein. The compositions of matter may include a base material interdigitated with an occlusal pad material, wherein the base material interdigitated with the occlusal pad material forms at least a portion of the dental appliance, in various aspects.

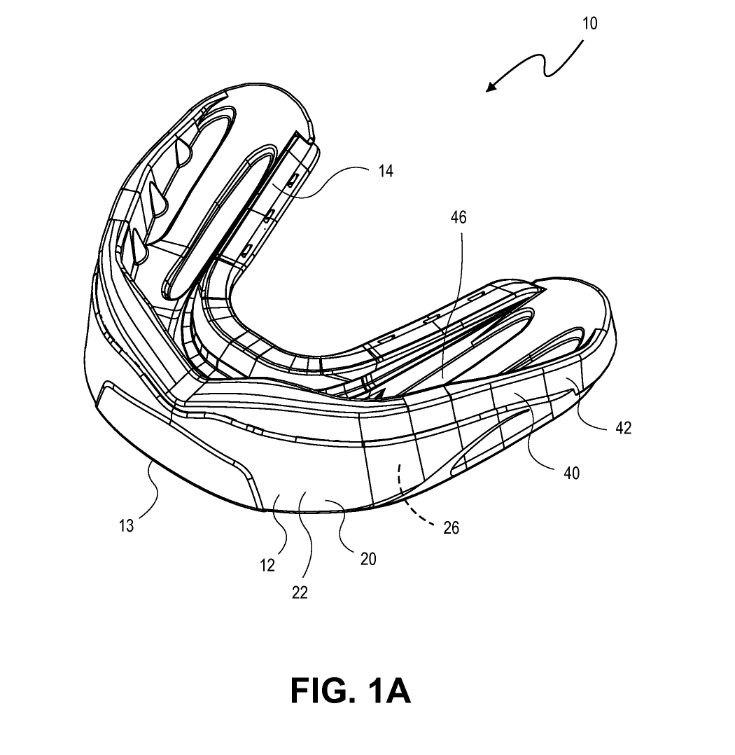

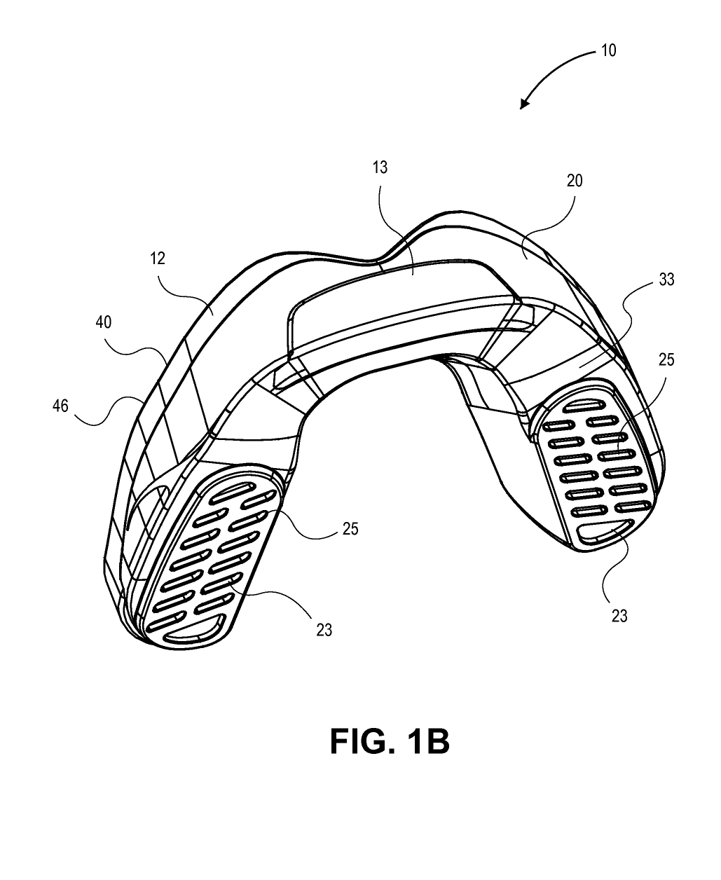

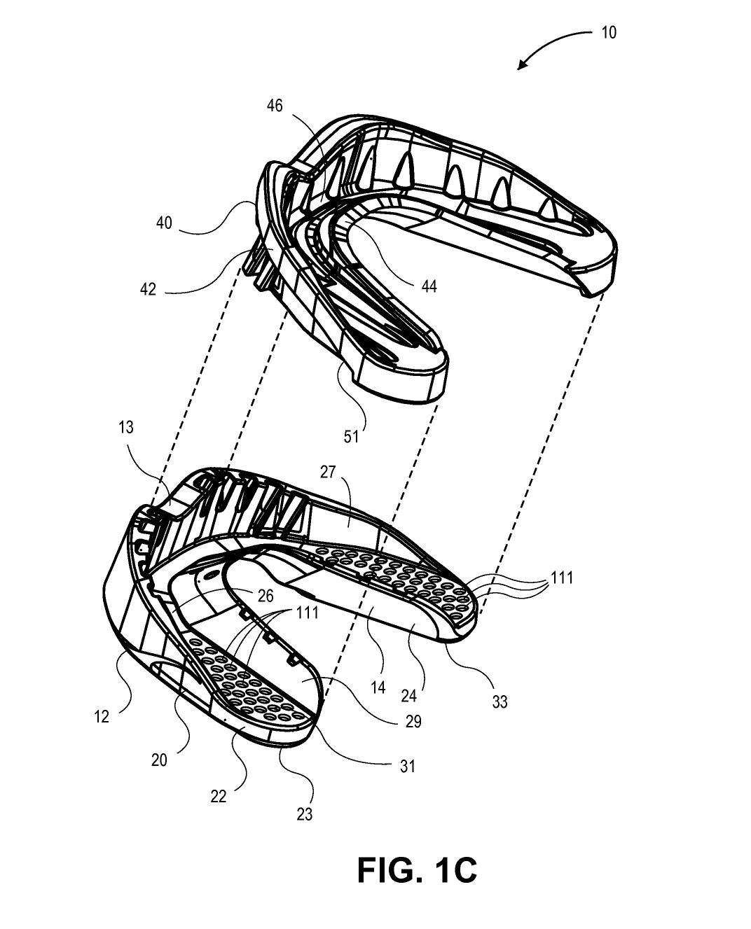

FIGS. 1A, 1B, and 1C illustrate an exemplary implementation of a dental appliance 10. As illustrated in FIG. 1A, the dental appliance 10 defines a buccal-labial side 12 that, when the dental appliance 10 is positioned in the mouth, is generally oriented toward the cheeks and/or lips of the user. The dental appliance 10 defines a lingual side 14 that is generally oriented toward the user's tongue when the dental appliance 10 is positioned in the mouth. Side portion 13 of the buccal-labial side 12 of dental appliance 10 is oriented toward the lips.

The dental appliance 10 includes a base 20 formed as a generally U-shaped member, the curved portions of which extend around the front of the user's mouth and the straight portions of which extend toward the posterior of the mouth, as illustrated in FIG. 1A. The base may have other shapes in other implementations. Base 20 defines a channel 26, as illustrated. The dental appliance 10 includes occlusal pad 40, which is generally received in channel 26 of base 20 such that occlusal pad 40 is bonded to base 20. The buccal-labial side 12 of dental appliance 10 is formed by portions of side 22 of base 20 in combination with portions of side 42 of occlusal pad 40. The lingual side 14 of dental appliance 10 is formed by portions of side 24 of base 20 in combination with portions of side 44 of occlusal pad 40 (see FIG. 1C).

As illustrated in FIG. 1A, occlusal pad 40 defines occlusal pad channel 46 that is adapted to engage one or more teeth of the user. The occlusal pad channel 46 may receive one or more teeth therein in order to removably secure the dental appliance 10 within the mouth to the one or more teeth of the user. With the teeth engaged in the occlusal pad channel 46, the dental appliance 10 in this implementation is generally frictionally secured to the teeth. In this implementation, the occlusal pad 40 is oriented to engage teeth of the upper jaw, but, in other implementations (not shown), the occlusal pad, such as occlusal pad 40, in combination with the base, such as base 20, could be adapted to engage the teeth of the lower jaw.

FIG. 1B illustrates portions of dental appliance 10 generally oriented toward side 33, which is generally opposite to the view illustrated in FIG. 1A. As illustrated in FIG. 1B, portions of side 33 of base 20 are formed into traction pads 23 that, in this implementation, contact the teeth of the lower jaw. In this implementation, treads 25 are shaped into traction pads 23 to prevent slippage between the traction pads 23 and the teeth. Traction pads 23 may be formed from a resilient material that deforms somewhat when the dental appliance 10 is compressed between the upper jaw and the lower jaw of the user in order to cushion the teeth 48 of the lower jaw. In some implementations, the traction pads 23 are formed of generally the same material as the remaining portions of base 20, and the traction pads 23 may be essentially a unitary portion of base 20. In other implementations, the traction pads 23 may be formed of a different material than that of base 20 and then secured to base 20 in various ways. In implementations in which the occlusal pad engages teeth of the lower jaw (not shown), the traction pads contact the teeth of the upper jaw.

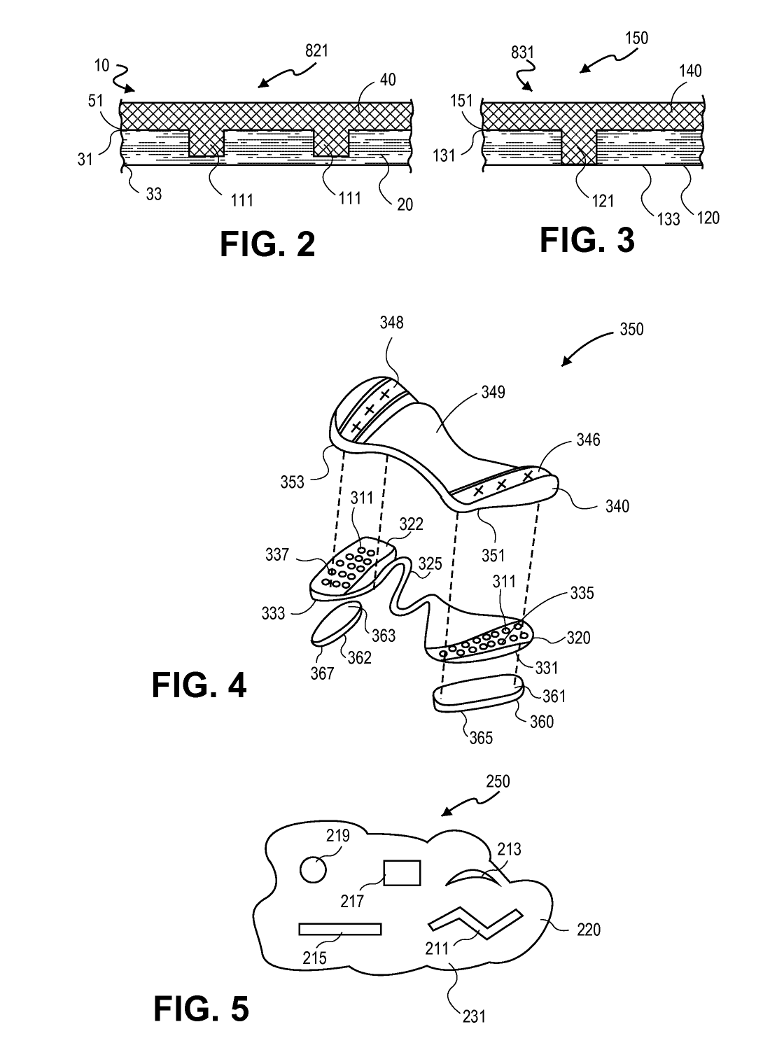

FIG. 1C illustrates by exploded view base 20 in combination with occlusal pad 46. As illustrated in FIG. 1C, occlusal pad 40 is received in channel 26 of base 20 so that side 42 of occlusal pad 40 is generally engaged with side 27 of base 20 and side 44 of occlusal pad 40 is generally engaged with side 29 of base 20. Indentations 111 are disposed about side 31 of base 20, as illustrated in FIG. 2C. In this implementation, indentations 111 have a generally hexagonal shape and are disposed about side 31 of base 20. In other implementations, the indentations may have other geometric shapes (see FIG. 4) and may be disposed, for example, about side 27, side 29, or side 31, or combinations thereof, or otherwise disposed about base 20.

In the complete assemblage of exemplary dental appliance 10, side 51 of occlusal pad 40 is engaged with side 31 of base 20 such that portions of occlusal pad 40 are interdigitated with the indentations 111 (see FIG. 2) to bond the occlusal pad 40 to base 20. In various implementations (not shown), other additional points of attachment may be provided to bond occlusal pad 40 to base 20.

The interdigitation of occlusal pad 40 with base 20 in dental appliance 10 is illustrated, for example, in FIG. 2. As illustrated in FIG. 2, indentations 111 extend partway through base 20 from side 31 toward side 33, so that indentations 111 partially penetrate base 20. In various implementations, the indentations penetrate to a depth of from about 0.2 mm to about 3 mm. The indentation diameter, including other such characteristic dimension, is generally within the range of from about 0.2 mm to about 3 mm, in various implementations.

Portions of occlusal pad 40 are received within indentation 111 such that occlusal pad 40 is interdigitated with base 20, as illustrated in FIG. 2. Accordingly, in this implementation, occlusal pad 40 is bonded to base 20 by interdigitation of occlusal pad 40 with base 20. Side 51 of occlusal pad 40 is biased against side 31 of base 20, as illustrated.

FIG. 3 illustrates an implementation of a portion of a dental appliance 150 in which occlusal pad 140 is bonded to base 120 by interdigitation of occlusal pad 140 with indentation 121 in base 120. As illustrated in FIG. 3, indentation 121 extends through base 120 between side 131 and 133 of base 120. Portions of occlusal pad 140 are received within indentation 121 of base 120 thereby bonding occlusal pad 140 to base 120 by interdigitation, in this implementation.

FIG. 4 illustrates an implementation of a dental appliance 350. Dental appliance 350, as illustrated in FIG. 4, includes occlusal pad 340 that is generally shaped to pass about the roof of the user's mouth and to engage teeth generally in the posterior portion of the upper jaw. Accordingly, occlusal pad channel 346 and occlusal pad channel 348 of occlusal pad 340 engage teeth on opposing sides of the upper jaw. Arch 349 connects occlusal pad channel 346 and occlusal pad channel 348 of occlusal pad 340, and arch 349 is generally positioned about the roof of the user's mouth when occlusal pad channel 346 and occlusal pad channel 348 are engaged with the user's teeth, in this implementation.

As illustrated in FIG. 4, bases 320, 322 are connected to one another by bridge 325, which has a serpentine shape in this implementation. In various implementations, bridge 325 may be embedded within occlusal pad 340.

As illustrated in FIG. 4, indentations 311 are disposed about sides 335, 337 of bases 320, 322, respectively to allow occlusal pad 340 to be bonded to bases 320, 322 by interdigitation. With bases 320, 322 so bonded to occlusal pad 340, portions of occlusal pad 340 are received within indentations 311 of bases 320, 322 so that occlusal pad 340 is, thus, interdigitated with bases 320, 322, in this implementation. Sides 351, 353 of occlusal pad 340 are biased against sides 335, 337 of bases 320, 322, respectively, when bases 320, 322 are bonded to occlusal pad 340, in this implementation.

Dental appliance 350, as illustrated in FIG. 4, includes traction pads 360, 362. Sides 365, 367 of traction pads 360, 362, respectively, are adapted to contact posterior teeth of the user's lower jaw. Sides 361, 363 of traction pads 360, 362 may be attached to sides 331, 333 of base 320, 322, respectively, in various ways, as would be recognized by those of ordinary skill in the art upon study of this disclosure.

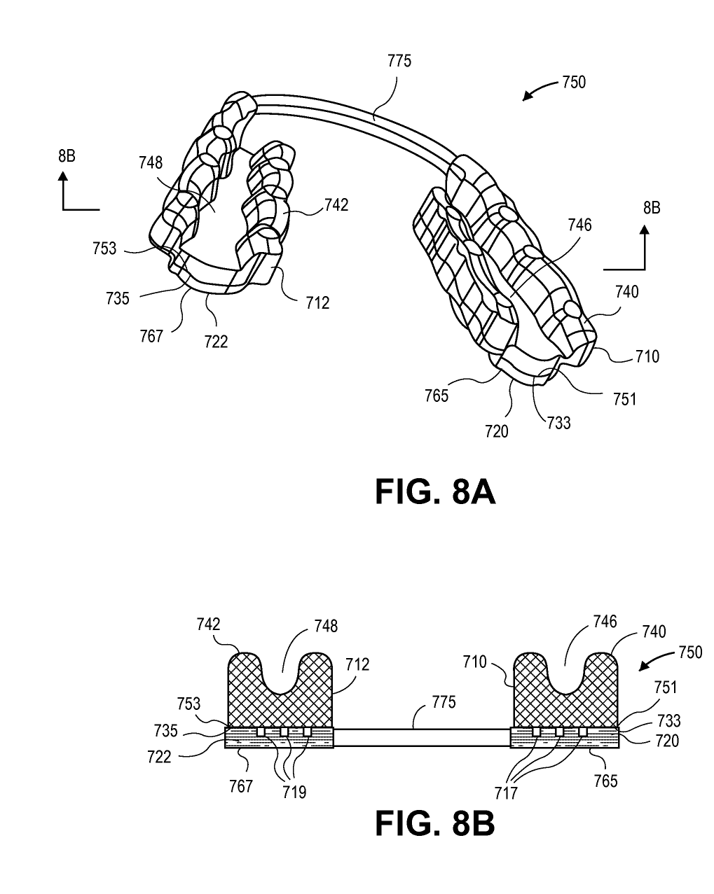

FIGS. 8A and 8B illustrate an implementation of a dental appliance 750. Dental appliance 750, as illustrated in FIG. 8A, includes occlusal pads 740, 742 bonded to bases 720, 722 to form bite pads 710, 712, respectively. In this implementation, bite pad 710 and bite pad 712 are connected to one another by labial bar 775.

As illustrated in FIG. 8A, occlusal pads 740, 742 define occlusal pad channels 746, 748, respectively, and occlusal pad channels 746, 748 engage teeth posterior teeth on opposing sides of the mouth. In some implementations, occlusal pad channels 746, 748 may engage teeth generally in the posterior portion of the upper jaw, and, in other implementations, occlusal pad channels 746, 748 may engage teeth generally in the posterior portion of the lower jaw.

Occlusal pads 740, 742 are bonded bases 720, 722, respectively, such that side 751 of occlusal pad 740 is bonded to side 733 of base 720 and side 753 of occlusal pad 742 is bonded to side 735 of base 722. Sides 765, 767 of bases 720, 722 are generally oriented opposite to sides 733, 735 of bases 720, 722, respectively. Sides 765, 767 of bases 720, 722 may include treads and so forth, and may otherwise be generally adapted to contact posterior teeth opposite to those engaged with occlusal pad channels 746, 748 of occlusal pads 740, 742. For example, when occlusal pad channels 746, 748 of occlusal pads 740, 742 engage teeth of the upper jaw, sides 765, 767 of bases 720, 722 generally contact teeth of the lower jaw. When, for example, occlusal pad channels 746, 748 of occlusal pads 740, 742 engage teeth of the lower jaw, sides 765, 767 of bases 720, 722 generally contact teeth of the upper jaw.

As illustrated in FIG. 8A, bite pad 710 and bite pad 712 are connected to one another by labial bar 775. Labial bar 775 may be formed of a variety of materials including those materials set forth herein as being suitable for use in the base, such as base 20, 120, 220, 320, 322, 720, 722, or of other materials, as would be recognized by those of ordinary skill in the art upon study of this disclosure. Labial bar 775 and bases 720, 722 may be formed as a unitary structure in some implementations. In other implementations, labial bar 775 may be attached to bases 720, 722 by various adhesives, mechanical connections, thermal bonding, or suchlike, and combinations thereof. In use, labial bar 775 generally passes about the anterior teeth of the user when occlusal pad channels 746, 748 of occlusal pads 740, 742 are engaged with the user's posterior teeth. Labial bar 775 may pass about either lingual or buccal-labial potions of the user's anterior teeth, in various implementations.

As illustrated in FIG. 8B, indentations 717, 719 are disposed about sides 733, 735 of bases 720, 722 to allow occlusal pads 740, 742 to be bonded to bases 720, 722 by interdigitation. Portions of occlusal pad 740 are received within indentations 717 of base 720, so that occlusal pad 740 is interdigitated with base 720, as illustrated. Portions of occlusal pad 742 are received within indentations 719 of base 722, so that occlusal pad 742 is interdigitated with base 722, as illustrated. Sides 751, 753 of occlusal pads 340, 342 are biased against sides 733, 735 of bases 720, 722, respectively, when bases 720, 722 are bonded to occlusal pads 740, 742, as illustrated in FIG. 8B.

FIG. 5 illustrates a base 220, which forms a portion of an implementation of a dental appliance 250. In this implementation, indentations 211, 213, 215, 217, 219 are disposed about side 231 of base 220. As illustrated in FIG. 5, indentations 211, 213, 215, 217, 219 form a zigzag channel, crescent, rectangle, square, and circle shape, respectively, in the plane of side 231 of base 220, and extend into base 220 therefrom. These zigzag channel, crescent, rectangle, square, and circle shapes are exemplary, and the indentations could assume other shapes and combinations of shapes in other implementations.

Indentations, such as indentations 111, 121, 211, 213, 215, 217, 219, 311, 717, 719 define an indentation size. The indentation size and/or shape of the indentation may be adapted to allow the occlusal pad material of the occlusal pad, such as occlusal pad 40, 140, 340, 740, 742 to penetrate the indentation when the occlusal pad material is generally in a flowable state. After the occlusal pad material has penetrated the indentations, the occlusal pad material may be cooled to a generally solid state such that the occlusal pad is bonded to the base, such as base 20, 120, 220, 320, 322, 720, 722, by interdigitation.

In use, the dental appliance, such as dental appliance 10, 150, 250, 350, 750 may be fit to the user's mouth by heating the dental appliance in hot water to soften the occlusal pad material of the occlusal pad, such as occlusal pad 40, 140, 340, 740, 742, into a pliable state. With the occlusal pad in the pliable state, the user may position the dental appliance in the mouth, and then may engage the occlusal pad of the dental appliance by biting the occlusal pad. When the user bites the occlusal pad, the occlusal pad material, which is in the pliable state, deforms until the occlusal pad assumes a shape that conforms to the user's teeth—i.e. the shape of the user's teeth is impressed into the occlusal pad material of the occlusal pad. The temperature at which the occlusal pad material of the occlusal pad becomes pliant is, for example, generally tolerable by the user when the user engages in this fitting process. Tolerable to the user, in various implementations, means unobjectionable to the user and non-injurious to the user. After the occlusal pad has conformed to the teeth, the user may cool the occlusal pad material by, for example, taking cool water into the mouth. Upon being cooled, the occlusal pad material is transformed into the non-pliant state in which the occlusal pad material recovers sufficient rigidity to retain its shape, which now conforms to the user's teeth as imprinted upon the occlusal pad by biting thereupon. The dental appliance is now fitted to the user's mouth.

Subsequent to being fitted to the user's mouth, the user may position the dental appliance in the mouth such that the occlusal pad receives the teeth to which it conforms. The dental appliance is, accordingly, removably secured to the teeth by frictional engagement with the user's teeth. With the dental appliance in place, the user may, for example, engage in various athletic activities, and the dental appliance may afford protection and/or confer other benefits upon the user while the user is so engaged.

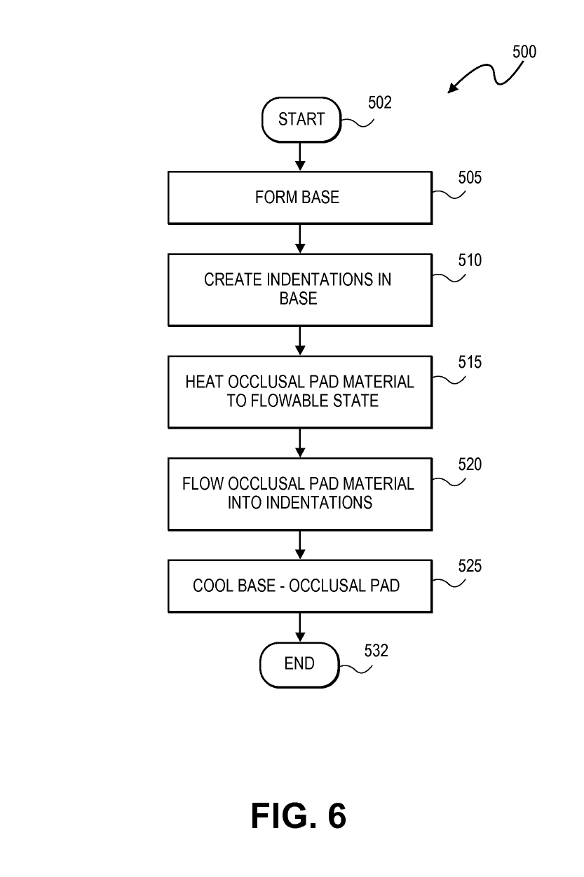

FIG. 6 illustrates an exemplary method 500 for making at least a portion of a dental appliance, such as dental appliance 10, 150, 250, 350, 750. Method 500 is initiated at step 502, and then passes to step 505. The base, such as base 20, 120, 220, 320, 322, 720, 722, is formed at step 505. The base may be formed in various ways or combinations of ways. For example, the base may be formed using a molding process such as injection molding, or the base may be machined from larger pieces of material.

Method 500 proceeds from step 505 to step 510. At step 510, indentations, such as indentations 111, 121, 211, 213, 215, 217, 219, 311, 717, 719, are created in the base. The indentations may be created, for example, by various cutting and machining operations that employ laser(s), cutting tool, water jets, stamping, and so forth. In some implementations, steps 505 and 510 may be combined generally into one operation so that the indentations are created in the base as the base is formed. For example, the indentations may be molded into the base as the base is formed in a molding operation—i.e. the indentations are part of the mold.

At step 515, the occlusal pad material of the occlusal pad, such as pad occlusal pad 40, 140, 340, 740, 742 is heated into generally a flowable state. The occlusal pad material generally in the flowable state is brought into contact with the base such that occlusal pad material flows into the indentations in the base, at step 520. The occlusal pad may be shaped and/or otherwise formed while the occlusal pad material is in the flowable state. Steps 515 and 520 may be combined or otherwise staged in various other implementations. For example, the occlusal pad material may be brought into contact with the base and then heated until occlusal pad material flows into the indentations. The occlusal pad material may melt at a lower temperature than the base material so that the base remains substantially in the solid state when the occlusal pad material is in the flowable state.

At step 525, the base in combination with the occlusal pad is cooled until the occlusal pad material assumes a generally solid state. Upon cooling, the base and the occlusal pad are bonded to one another by interdigitation of the occlusal pad material into the base material via the indentations in the base. Method 500 then terminates at step 532.

In various implementations, the side of the base to which the occlusal pad is to be bonded, such as side 27, 31, 131 231, 335, 337, 733, 735 is treated with an electrical discharge surface treatment such as a plasma treatment, corona treatment, and similar, and combinations thereof. The electrical discharge treatment may extend into the indentations to encompass portions of the base material that surround the indentations. Electrical discharge treatment of the side of the base prior to bonding of the occlusal pad thereto may improve the bond between the base and the occlusal pad by reduction of the surface tension of the base material generally proximate the side. The step of treating the side of the base with the electrical discharge surface treatment may be performed prior to step 520 in the exemplary process 500.

In various implementations, the base may be subjected to an annealing step prior to bonding the occlusal pad thereto. Annealing is a heat treatment that relieves mechanical stresses in the base induced when the base is formed by, for example, high pressure-high temperature injection molding. Annealing may improve the bond between the base and the occlusal pad. Accordingly, the step of annealing the base may be performed, for example, prior to step 520 in the exemplary process 500.

Various implementations of the methods may include the annealing step, the treating with the electrical discharge treatment step, as well as various combinations thereof. Combinations of the annealing step and the treating with the electrical discharge treatment step may be sequenced in various ways.

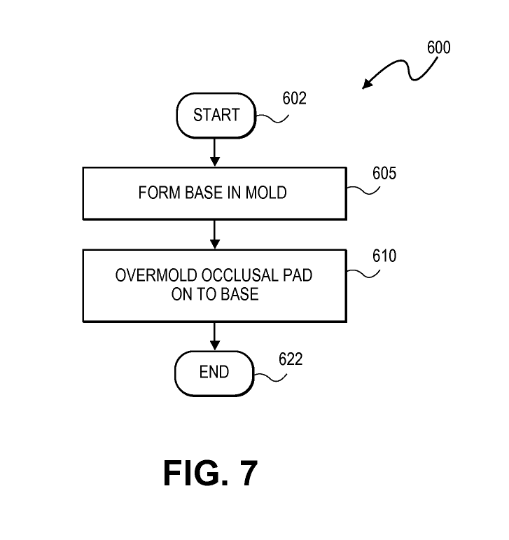

At least portions of the dental appliance may be formed by a two-step injection molding process in method 600, as illustrated by the process flow chart in FIG. 7. Method 600 is entered at step 602 and then proceeds to step 605. In the implementation of method 600, the base with indentations therein is formed in the first step of the injection molding process at step 605. At step 610 of this exemplary process, the occlusal pad material is over-molded onto the base such that the occlusal pad material is interdigitated with the base. Method 600 then terminates at step 622.

In some implementations of method 600, the base including indentations therein is formed in a mold at step 605. The base is then inserted into a second mold (not shown) at step 610. The occlusal pad is over-molded upon the base in the second mold such that the occlusal pad material is interdigitated with the base.

In other implementations of method 600, a multi-shot mold is used. The base including indentations therein is formed in the mold by a first shot at step 605, and the occlusal pad is over-molded upon the base and otherwise formed by the second shot such that the occlusal pad is interdigitated with the base at step 610. Use of the multi-shot mold obviates the need for multiple molds, reinsertion of the base into the mold, and so forth.

Compositions of matter include occlusal pad material interdigitated with base material such as composition such as composition 821 (FIG. 2) and composition 831 (FIG. 3). The base material in compositions 821, 831 may include styrene block copolymer, ethylene vinyl acetate, polyolefin elastomer, thermoplastic rubber, polypropylene, or injection molding resin. In various implementations, the base material may include a mixture of styrene block copolymer and ethylene vinyl acetate, a mixture of a styrene block copolymer and a polyolefin elastomer, or a mixture of a thermoplastic rubber and a polyolefin elastomer.

The occlusal pad material, in various implementations such as compositions 821, 831, may include polycaprolactone or ethylene vinyl acetate. In various implementations, the occlusal pad material may include a mixture of polycaprolactone and ethylene vinyl acetate. In various implementations, the occlusal pad material may include a mixture of polycaprolactone and a polyolefin elastomer, and the polyolefin elastomer may be a copolymer of ethylene and octene-1.

The foregoing discussion along with the Figures discloses and describes various exemplary implementations. These implementations are not meant to limit the scope of coverage, but, instead, to assist in understanding the context of the language used in this specification and in the claims. Accordingly, variations of the apparatus, methods, and compositions of matter that differ from these exemplary implementations may be encompassed by the appended claims. Upon study of this disclosure and the exemplary implementations herein, one of ordinary skill in the art may readily recognize that various changes, modifications and variations can be made thereto without departing from the spirit and scope of the inventions as defined in the following claims.

1. An dental appliance, comprising:
a base adapted to bias against teeth of the lower jaw, the base comprised of a base material of a resilient nature having partially penetrating indentation disposed therein; and
an occlusal pad comprised of a occlusal pad material transformable between a non-pliant state and a pliant state to allow fitment of the occlusal pad to the teeth, the occlusal pad interdigitated with the indentations thereby securing the occlusal pad to the base such that the occlusal pad is engageable only with teeth of the upper jaw.

2. The Apparatus, as in claim 1, further comprising:
the base defines a channel, at least portions of the channel receives at least portions of the occlusal pad.

3. The Apparatus, as in claim 1, wherein the base is generally configured as a U-shaped member.

4. The Apparatus, as in claim 1, wherein at least portions of the base are configured as a traction pad.

5. The Apparatus, as in claim 1, wherein the base material comprises a material chosen from the group consisting of styrene block copolymer, ethylene vinyl acetate, polyolefin elastomer, thermoplastic rubber, polypropylene, and injection molding resin.

6. The Apparatus, as in claim 1, wherein the occlusal pad material comprises a material chosen from the group consisting of polycaprolactone, ethylene vinyl acetate, and polyolefin elastomer.

7. The Apparatus, as in claim 1, wherein at least a portion of the indentations partially penetrate the base.

8. The Apparatus, as in claim 1, wherein at least a portion of the indentations extend through the base.

9. The Apparatus, as in claim 1, wherein the occlusal pad is interdigitated with the indentations of the base in a way generally resistive to the repeated application of oral forces thereto.

10. The Apparatus, as in claim 1, further comprising:
an indentation size defined by the indentation, the indentation size sufficient to allow the occlusal pad material to penetrate the indentation when the occlusal pad material is generally in a flowable state.

11. The Apparatus, as in claim 1, wherein the indentation diameter is generally within the range of from about 0.2 mm to about 3 mm.

12. A method of making a dental appliance, comprising the steps of:
creating indentations in a base, the base comprising base material;
interdigitating an occlusal pad with the indentations in the base, the indentations partially penetrate the base, the occlusal pad comprising occlusal pad material differing from the base material, the occlusal pad adapted for fitably engaging one or more teeth of a user by being transformable between a non-pliant state and a pliant state.

13. The Method, as in claim 12, wherein the base generally defines a channel, at least portions of the channel generally receive at least portions of the occlusal pad.

14. The Method, as in claim 12, wherein the base is generally configured as a U-shaped member.

15. The Method, as in claim 12, wherein at least a portion of the base is configured as a traction pad.

16. The Method, as in claim 12, wherein the base material comprises a material chosen from the group consisting of styrene block copolymer, ethylene vinyl acetate, polyolefin elastomer, thermoplastic rubber, polypropylene, and injection molding resin

17. The method, as in claim 12, further comprising:
the occlusal pad material is transformable between a non-pliant state and a pliant state at a temperature less than about 100° C.

18. The Method, as in claim 12, wherein the occlusal pad material comprises a material chosen from the group consisting of polycaprolactone, ethylene vinyl acetate, and polyolefin elastomer.

19. The Method, as in claim 12, wherein at least a portion of the indentations partially penetrate the base.

20. The Method, as in claim 12, wherein at least a portion of the indentations extend through the base.

21. The Method, as in claim 12, wherein the occlusal pad is interdigitated with the indentations of the base in a way generally resistive to the repeated application of oral forces thereto.

22. The Method, as in claim 12, wherein an indentation size defined by the indentation is sufficient to allow the occlusal pad material to penetrate the indentation when the occlusal pad material is in a flowable state.

23. The Method, as in claim 12, wherein the indentation diameter is generally within the range of from about 0.2 mm to about 3 mm.

24. The Method, as in claim 12, further comprising the step of:
treating the base with the electrical discharge surface treatment prior to the step of interdigitating an occlusal pad with the indentations in the base.

25. The Method, as in claim 12, further comprising the step of:
annealing the base prior to the step of interdigitating an occlusal pad with the indentations in the base.

26.-27. (canceled)
